(19) United States
(12) Patent Application Publication
(10) Pub. No.: US 2008/0159467 A1
(43) Pub. Date: Jul. 3, 2008

(54) Method for determining the rotation speed of rotating shaft

(76) Inventor: Uwe Kassner, Moeglingen (DE)

Correspondence Address: KENYON & KENYON LLP, ONE BROADWAY, NEW YORK, NY, 10004, US

(21) Appl. No.: 12/002,542

(22) Filed: Dec. 17, 2007

(30) Foreign Application Priority Data
Dec. 27, 2006 (DE) 102006061580.8

(51) Int. Cl. G01P 3/64

(52) U.S. Cl. 377/20

(57) ABSTRACT

A method for determining the rotation speed of a rotating shaft that has associated with it a means that has markings which produce an electrical signal upon being carried past a sensor element of a sensor, the sensor encompassing an evaluation device that counts the markings carried past the sensor element within a gate time and transfers them to a control unit as a numerical value. The gate time is derived from a time increment, and a pulse having an actual time duration derived from the time increment is transferred to the control unit and is compared by the control unit with a target time duration, the numerical value being corrected using a correction value that is ascertained from a comparison of the actual time duration with the target time duration.

### FIELD OF THE INVENTION

The present invention relates to a method and an assemblage for determining the rotation speed of a rotating shaft that has associated with it a means that has markings which produce an electrical signal upon being carried past a sensor element of a sensor, the sensor encompassing an evaluation device that counts the markings carried past a sensor element within a gate time and transfers them to a control unit as a numerical value. The present invention further relates to a sensor for an assemblage of this kind, as well as a computer program for carrying out the method.

### BACKGROUND INFORMATION

In the related art, the rotation speed of a rotating shaft is measured, for example, by measuring markings of a sensor wheel that is carried past a sensor as the shaft rotates, and there generates electrical signals associated with increments of the rotary motion of the shaft. It is usual in the case of crankshafts, for example, to dispose a sensor wheel having teeth and tooth gaps, which wheel, upon being carried past a, for example, Hall element or inductive sensor element, triggers corresponding voltage pulses as the increment markers are carried past. The voltage pulses are transferred, usually as a pulse train having two levels of an electrical voltage or an electrical current, to a downstream electronic control unit. Further signal processing then takes place therein. It is usual to determine a time offset of two successive pulses, from which offset an instantaneous rotational velocity of the sensor wheel is ascertained.

As the rotation speed increases, the demands on this type of signal transfer system increase. On the one hand, the pulses must become increasingly short in time; on the other hand, in the context of evaluation in the electronic control unit, the load on a microprocessor arranged therein increases in terms of measuring the pulse frequency or the period. A very wide measurement range must be covered, for example, by a sensor that determines the rotation speed of an exhaust-gas turbocharger on an internal combustion engine. The measurement range here is in a range from approximately 20,000 to 300,000 rpm. For a sensor of this kind, interfaces and methods for data transfer therefore exist that transfer the measured rotation speed to the electronic control unit as a coded datum. A high level of insensitivity to signal interference and a constant load on the electronic control unit are advantageous, since the rotation speed information is transferred at a constant data rate.

One problem with such methods for data transfer is that only a relatively inaccurate clock cycle is available in the sensor. Whereas a relatively complex control unit usually contains a quartz oscillator, in a sensor only a relatively inaccurate electronic circuit is present in order to generate a clock cycle.

### SUMMARY OF THE INVENTION

An object of the present invention is therefore to increase the measurement accuracy of a sensor that can transfer rotation-speed or angle information in coded fashion.

This problem is solved by a method for determining the rotation speed of a rotating shaft that has associated with it a means that has markings which produce an electrical signal upon being carried past a sensor element of a sensor, the sensor encompassing an evaluation device that counts the markings carried past the sensor element within a gate time and transfers them to a control unit as a numerical value, the gate time being derived from a time increment; and that a pulse having an actual time duration derived from the time increment is transferred to the control unit and is compared by the control unit with a target time duration; and that the numerical value is corrected using a correction value that is ascertained from a comparison of the actual time duration with the target time duration. The correction value can be a factor, a quotient, or any other function. The time increment is usually the clock cycle of a clock or the period length of a clock. Provision is preferably made that the numerical value is corrected using a factor as a correction value, the correction value by preference being the quotient of the target time duration divided by the actual time duration. The time increment is preferably the time duration of one pulse of a clock or the period length of a clock. The gate time is by preference a constant multiple of the period length of the clock. Provision is made that the pulse having an actual time duration derived from the time increment (the period length) represents at least one bit of a datagram. The bit has a constant length within the datagram. The bit is by preference coded as a pulse of constant time duration. Provision is preferably made that the pulse having an actual time duration derived from the time increment represents a synchronization bit or a synchronization pulse of the datagram.

The problem stated above is also solved by an assemblage of a sensor and a control unit for determining the rotation speed of a rotating shaft that has associated with it a means that has markings which produce an electrical signal upon being carried past a sensor element of a sensor, the sensor encompassing an evaluation device that counts the markings carried past the sensor element within a gate time and transfers them to a control unit as a numerical value, the gate time being derived from a time increment; and that a pulse having an actual time duration derived from the time increment is transferred to the control unit and is compared by the control unit with a target time duration; and that the numerical value is corrected using a value that is ascertained from a comparison of the actual time duration with the target time duration.

The problem stated above is also solved by a sensor for an assemblage for determining a rotation speed of a rotating shaft, which sensor is set up to carry out a method according to the present invention, and by a computer program having program code for carrying out all the steps according to a method according to the present invention when the program is executed in a computer.

### BRIEF DESCRIPTION OF THE DRAWINGS

FIG. 1 is a sketch of an assemblage of a sensor wheel and a sensor.

FIG. 2 is a sketch relating to the signal processing and signal transfer of the sensor in FIG. 1.

FIG. 3 shows a signal profile over time of the signal transferred from the sensor to a control unit.

FIG. 4 is a schematic sketch of an arrangement according to the present invention.

### DETAILED DESCRIPTION

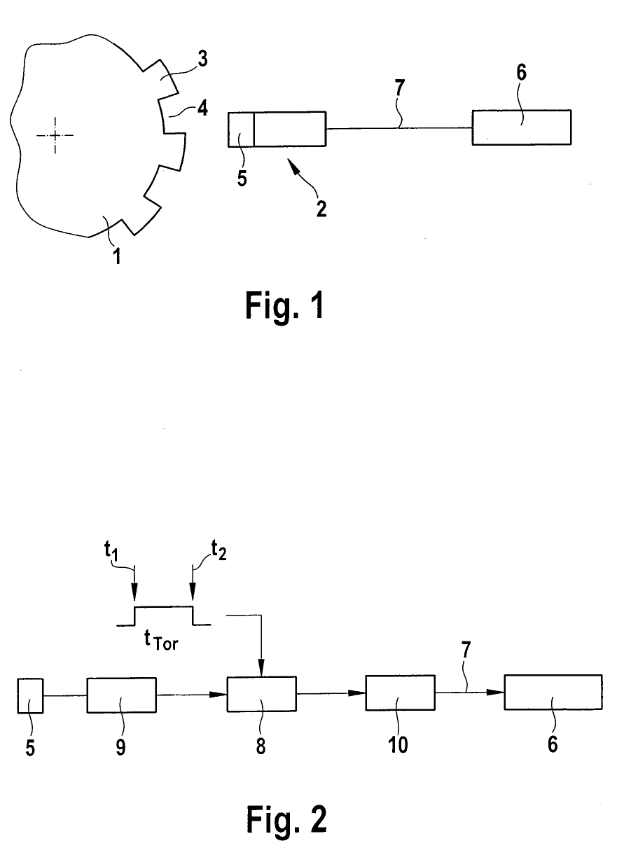

FIG. 1 shows an assemblage of a sensor wheel 1 and a sensor 2. Sensor wheel 1 is joined to a crankshaft (not depicted) of an internal combustion engine, so that sensor wheel 1 co-rotates with the crankshaft. Sensor wheel 1 encompasses markings, for example in the form of an alternating pattern of teeth 3 and tooth gaps 4. As the markings are carried past sensor 2, the markings trigger electrical signals of a sensor element 5. Sensor element 5 can be, for example, a Hall sensor, an inductive sensor, or the like, so that the electrical signal of sensor element 5 is a square-wave voltage that corresponds to a development of the sequence of teeth 3 and tooth gaps 4 of sensor wheel 1. Teeth 3 and tooth gaps 4 generate two different states in sensor 2. These states are transferred to an electronic control unit 6, for example as a pulse train having two levels of an electrical voltage (square-wave voltage) or of an electrical current. Data transfer between sensor 2 and control unit 6 is accomplished via a data line 7. Further signal processing takes place in control unit 6, which can be, for example, an engine control unit of an internal combustion engine. It is usual to determine the time offset of two successive pulses, with which an instantaneous rotational velocity of the sensor wheel can be ascertained.

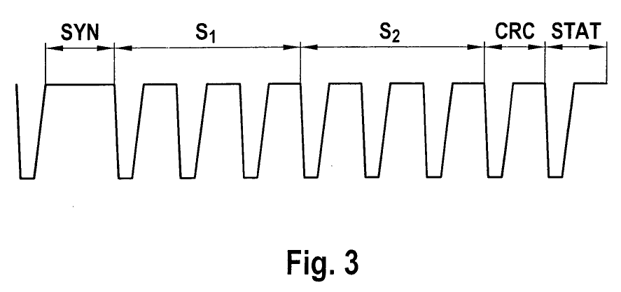

FIG. 2 shows one approach, known per se, for appropriate signal processing of the output signals of sensor element 5. A counter 8 is reset at time t₁ at the beginning of a constant gate time tTor; counter 8 then counts all the events (e.g. changes from tooth to tooth gap) sensed by a signal processing unit 9 until the end of gate time tTor at time t₂. Sensor element 5 is connected to signal processing unit 9. Sensor element 5 supplies to signal processing unit 9 an electrical signal, as set forth above, in accordance with the teeth and tooth gaps that have been carried past sensor element 5. The content of counter 8 is an indication of the instantaneous rotation speed within gate time tTor. The number of teeth and tooth gaps carried past sensor element 5 within gate time tTor is ascertained and stored by counter 8 as a numerical value. Based on the inherently known angle increment between adjacent tooth/tooth-gap pairs, the angular velocity of the shaft can thus be determined directly as the quotient of the swept angle divided by the gate time. The swept angle is the product of the number of teeth and tooth gaps counted during the gate time times the angle increment of one pair of teeth and tooth gaps. The counter status is converted, in a coding unit 10 downstream from counter 8, into a suitable data protocol that is transferred via the data line to control unit 6 as an electrical signal. Signal processing unit 9, counter 8, and coding unit 10 are by preference combined into one common integrated circuit of the sensor. Gate time tTor is generated by a circuit integrated into an oscillator.

FIG. 3 shows an example of one such data protocol that is transferred via signal line 7 by sensor 2, or coding unit 10 of sensor 2, to control unit 6. The data are transferred in the form of pulses that each represent four bits. Firstly, a synchronization pulse Syn having a typical duration of 168 μs is transferred. This is followed by a signal 1 as a sequence of three pulses that each represent a four-bit data word. Following signal 1, labeled S₁ in FIG. 3, is a similar second signal S2 that is once again made up of three four-bit data words. Following this, a checksum CRC is transferred, and the checksum is followed by a status bit STAT. Each four-bit data word is represented by a corresponding duration of the respective pulse, for example in a form such that the duration of the pulse is 36 μs+x*3, where x is a number between 0 and 15 (i.e. can assume 16 values that represent a four-bit data word). The approach presented above is defined in SAE J2716 as a Single Edge Nibble Transmission (SENT) for Automotive Applications, as a standard solution in the automotive sector. A variety of codings are nevertheless possible for such digital interfaces, usually differing only in terms of the manner in which the individual bits are coded. Each of these codings is fundamentally made up of a sequence of high and low values, i.e. a train of pulses, on a data line.

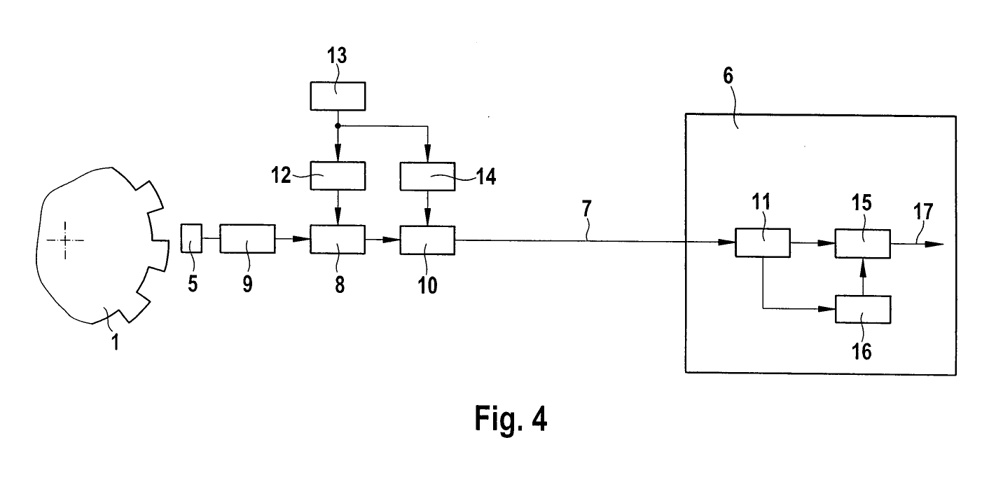

FIG. 4 shows an exemplary embodiment of an assemblage according to the present invention for carrying out a method according to the present invention. Sensor wheel 1, with which sensor element 5 is associated, is depicted schematically. The output signal of sensor element 5 is applied to signal processing unit 9, whose output in turn is applied to counter 8, whose output is in turn connected to coding unit 10. Coding unit 10 is connected via a data line 7 to a pulse time measuring apparatus 11 of control unit 6. Additionally associated with counter 8 is a divider stage 12 that, from the clock cycle of a clock 13, generates gate time tTor and sends it to the input of counter 8. The basic clock cycle for the digital data protocol generated in coding unit 10 is generated in parallel fashion, by way of a divider stage 14, from the clock cycle of clock 13. Pulse lengths of the data protocol are therefore generated by divider stage 14 and coding unit 10 from the clock cycle of the clock. Both gate time tTor and the basic clock cycle of the data protocol are thus derived from a clock cycle of the clock. The clock is usually a simple PLL circuit, and therefore has only a relatively low clock accuracy.

Some of the pulses (as shown in FIG. 3) of the data protocol that is used have a constant length. This applies in particular to synchronization pulses (synchronization bit). The duration t_{Syn} of the synchronization pulse is generated as a multiple of the period length T of clock 13, i.e. Δt_{Syn}=n*T. Correspondingly, however, the duration of gate time tTor is also generated as a multiple of the period length T of clock 13, i.e. tTor=m*T. The length of gate time tTor can thus be ascertained indirectly via a measurement of the time duration of the synchronization pulse. When factors n and m are constant, the ratio of Δt_{Syn} to tTor is equal to that of n to m. n and m are constant values and are therefore known and stored in the control unit. A correction value for the actual length tTor_{actual} of the gate time can therefore be determined by measuring the actual pulse length tSyn_{actual}. To do so, the actual value tSyn_{actual} of the duration of the synchronization pulse is compared with a target value tSynₛₑₜₚₒᵢₙₜ for the duration of the synchronization pulse. The comparison can be accomplished, for example, by calculating the quotient tSynₛₑₜₚₒᵢₙₜ/tSyn_{actual}, i.e. by ascertaining the quotient of the target value divided by the actual value. The target value tTorₛₑₜₚₒᵢₙₜ of gate time tTor is also related to the actual value tTor_{actual} of gate time tTor in accordance with this quotient. Therefore, tSynₛₑₜₚₒᵢₙₜ/tSyn_{actual}=tTorₛₑₜₚₒᵢₙₜ/tTor_{actual}. The quotient is referred to as the factor K=tSynₛₑₜₚₒᵢₙₜ/tSyn_{actual}=tTorₛₑₜₚₒᵢₙₜ/tTor_{actual}. The number z_{actual} of teeth or tooth gaps that is measured and transferred to control unit 6 is then multiplied by this factor. The corrected number Z_{cor}=Z_{actual}*K=Z_{actual}*tSynₛₑₜₚₒᵢₙₜ/tSyn_{actual} is thus corrected by an amount equal to the deviation of the actual clock cycle of the clock from a target clock cycle.

From the duration tSyn_{actual} of the synchronization pulse, measured in pulse time measuring apparatus 11 and having a target duration tSynₛₑₜₚₒᵢₙₜ of 168 μs according to FIG. 3, the correction factor K is determined in a unit 16. The data value transmitted via data line 7, i.e. the number z of teeth or tooth gaps counted during gate time tTor, is multiplied by this factor K in a correction unit and thereby corrected. This factor K is the ratio of the nominal duration of the synchronization bit to the instantaneously measured duration. The correct or corrected rotation speed datum is then available as a signal at output 17.

The error in the gate time, and thus the error in the rotation speed, is thereby completely compensated for in the control unit. An error in terms of time acquisition for the synchronization bit still remains, but this error is negligible if, as is usual, a microprocessor of control unit 6 obtains its clock cycle from a quartz oscillator.

If the frequency of clock 13 deviates from its nominal value by, for example, +10%, the gate time is therefore too short by a factor of 1/1.1, and the rotation speed that is determined is too low by a factor of 1/1.1. This (erroneous) value is transferred via signal line 7 to control unit 6. Pulse time measuring apparatus 11 measures the duration of the synchronization bit, which is now likewise shorter by a factor of 1/1.1 than the duration pertinent to the nominal value of clock 13. The quotient of the known nominal duration of the synchronization bit divided by the measured duration of the synchronization bit, i.e. a comparison of the target value of the duration of the synchronization bit or pulse and the actual value of the duration of the synchronization pulse or bit, yields in this case a correction factor of 1.1, by which the rotation speed value is multiplied in correction unit 15.

What is claimed is:

1. A method for determining a rotation speed of a rotating shaft that has associated with it a device that has markings which produce an electrical signal upon being carried past a sensor element of a sensor, the sensor encompassing an evaluation device that counts the markings carried past the sensor element within a gate time and transfers them to a control unit as a numerical value, the method comprising:
deriving the gate time from a time increment;
transferring a pulse having an actual time duration derived from the time increment to the control unit;
comparing, by the control unit, the actual time duration with a target time duration; and
correcting the numerical value using a correction value that is ascertained from a comparison of the actual time duration with the target time duration.

2. The method according to claim 1, wherein the numerical value is corrected using a factor as the correction value.

3. The method according to claim 1, wherein the correction value is a quotient of the target time duration divided by the actual time duration.

4. The method according to claim 1, wherein the time increment is a period length of a clock.

5. The method according to claim 4, wherein the gate time is a constant multiple of the period length of the clock.

6. The method according to claim 1, wherein the pulse having an actual time duration derived from the time increment represents at least one bit of a datagram.

7. The method according to claim 6, wherein the pulse having an actual time duration derived from the time increment represents a synchronization bit of the datagram.

8. A system comprising:
a sensor and a control unit for determining a rotation speed of a rotating shaft that has associated with it a device that has markings which produce an electrical signal upon being carried past a sensor element of the sensor, the sensor encompassing an evaluation device that counts the markings carried past the sensor element within a gate time and transfers them to the control unit as a numerical value, the gate time being derived from a time increment,
wherein the control unit receives a pulse having an actual time duration derived from the time increment, compares the actual time duration with a target time duration, and corrects the numerical value using a correction value that is ascertained from a comparison of the actual time duration with the target time duration.

9. A computer-readable medium containing a computer program which when executed by a processor performs the following method for determining a rotation speed of a rotating shaft that has associated with it a device that has markings which produce an electrical signal upon being carried past a sensor element of a sensor, the sensor encompassing an evaluation device that counts the markings carried past the sensor element within a gate time and transfers them to a control unit as a numerical value:
deriving the gate time from a time increment;
transferring a pulse having an actual time duration derived from the time increment to the control unit;
comparing, by the control unit, the actual time duration with a target time duration; and
correcting the numerical value using a correction value that is ascertained from a comparison of the actual time duration with the target time duration.
